(19) United States
(12) Patent Application Publication
(10) Pub. No.: US 2024/0330704 A1
(43) Pub. Date: Oct. 3, 2024

(54) FEDERATED DECISION TREE LEARNING VIA PRIVATE SET INTERSECTION

(71) Applicant: VMware LLC, Palo Alto, CA (US)

(72) Inventors: Avishay Yanai, Herzliya (IL); Shay Vargaftik, Herzliya (IL); Yaniv Ben-Itzhak, Herzliya (CN); Igor Golikov, Herzliya (IL)

(21) Appl. No.: 18/190,830

(22) Filed: Mar. 27, 2023

(51) Int. Cl. G06N 3/098

(52) U.S. Cl. CPC G06N 3/098

(57) ABSTRACT

A protocol for federated decision tree learning is provided. In one set of embodiments, this protocol employs a cryptographic technique known as private set intersection (PSI) (and more precisely, a variant of PSI known as quorum private set intersection analytics (QPSIA)) to carry out federated learning of decision trees in an efficient and effective manner.

### BACKGROUND

Unless specifically indicated herein, the approaches described in this section should not be construed as prior art to the claims of the present application and are not admitted as being prior art by inclusion in this section.

Federated learning (FL) is a machine learning (ML) technique that allows multiple clients to collaboratively train an ML model on training datasets that are local to each client. Federated decision tree learning is a type of FL that pertains to the training a decision tree, which is an ML model that maps out decisions and outcomes for classifying data instances via a flowchart-like tree structure.

Because of the popularity and usefulness of decision trees for various ML applications, federated decision tree learning has become an important tool, particularly in the context of cross-silo and horizontal FL (i.e., a setting where the FL clients are part of separate (i.e., siloed) organizations and their training datasets share the same feature space (i.e., columns) but include different data instances (i.e., rows)). However, existing federated decision tree learning protocols suffer from a number of drawbacks, such as poor efficiency and/or effectiveness, that limit their use in real-world scenarios.

### BRIEF DESCRIPTION OF THE DRAWINGS

FIG. 1 depicts an example FL environment.

FIG. 2 depicts an example table structure for a training dataset.

FIG. 3 depicts an example decision tree.

FIG. 4 depicts a workflow for implementing federated decision tree learning according to certain embodiments.

FIG. 5 depicts an example scenario with respect to the workflow of FIG. 4 according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

Embodiments of the present disclosure are directed to a novel federated decision tree learning protocol referred to herein as “PSI4FDTL.” At a high level, the PSI4FDTL protocol employs a cryptographic technique known as private set intersection (PSI) (and more precisely, a variant of PSI known as quorum private set intersection analytics (QPSIA), explained below) to carry out federated learning of decision trees in an efficient and effective manner.

### 1.Example FL Environment and General Protocol Design

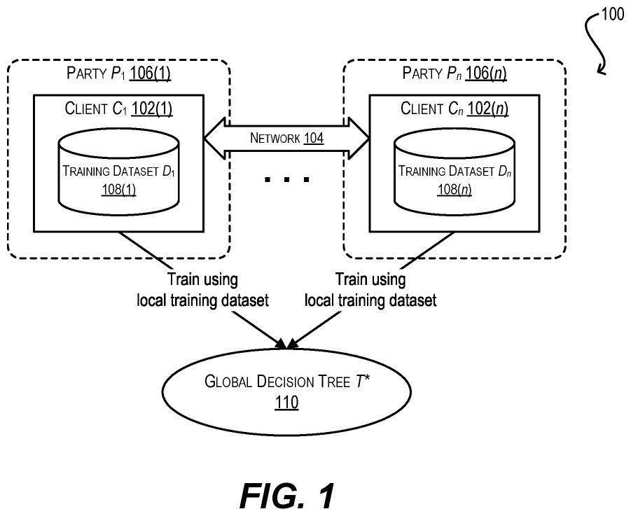

FIG. 1 depicts an example FL environment 100 in which embodiments of the present disclosure may be implemented. As shown, FL environment 100 includes a set of n clients C₁, . . . , Cₙ (reference numerals 102(1)-(n)) that are communicatively coupled via a network 104. Each client Cᵢ for i=1, . . . , n is a computer system or group of computer systems that belongs to a party Pᵢ (reference numeral 106) and maintains a training dataset Dᵢ (reference numeral 108) that is local to Cᵢ/Pᵢ (and thus is not directly accessible by the other clients/parties). Parties P₁, . . . , Pₙ may be, e.g., different individuals, organizations, or computing environments (e.g., data centers).

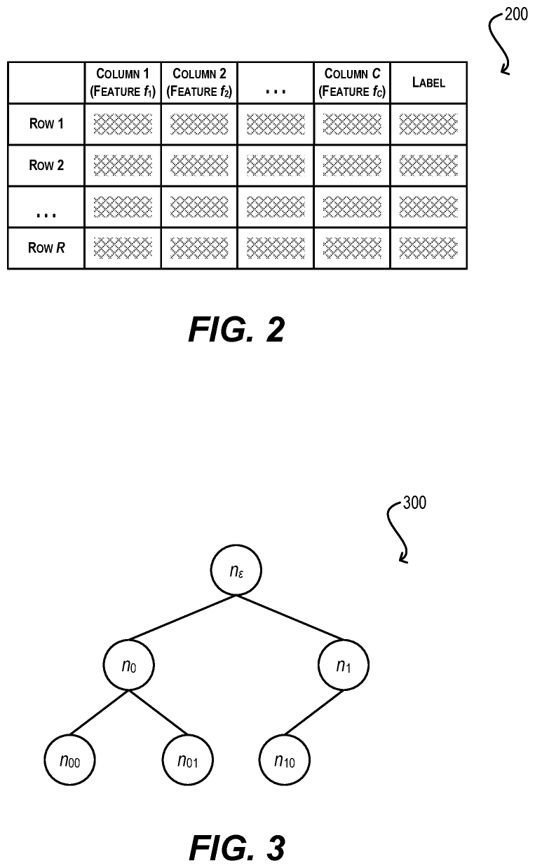

FIG. 2 depicts an example table structure 200 for training datasets D₁, . . . , Dₙ of FIG. 1 according to certain embodiments. As shown in FIG. 2, table 200 includes R rows corresponding to the training dataset's data instances and C+1 columns. Each of the first C columns is associated with a feature (also known as attribute) fᵢ from a set of features F={f₁, . . . , f_{c}}. Each feature fᵢ is in turn associated with a domain Zᵢ that contains the set of possible values for fᵢ. For instance, if feature f₁ is “day of the week,” domain Z₁ would be {Monday, Tuesday, Wednesday, Thursday, Friday, Saturday, Sunday}. The last column of table 200 is associated with a set of labels L={l₁, . . . , l_{|L|}}. Accordingly, each row (i.e., data instance) of this table is a (C+1)-dimension vector sampled from a distribution over Z₁ × . . . . ×Z_{c}×L. The label in a particular row r indicates the “correct” classification for the data instance represented by r (or in other words, the classification that should be output by an ML model trained on this data instance), given the feature values in the first C columns of r.

For purposes of this disclosure, it is assumed that training datasets D₁, . . . , Dₙ all share the same C+1 columns corresponding to features F and labels L depicted in table 200, but may have different rows. In addition, it is assumed that these training datasets contain sensitive information that parties P₁, . . . , Pₙ wish to keep secret from one another. For example, each party Pᵢ may be a hospital in a group of hospitals and training dataset Dᵢ may be a confidential patient record database of that hospital. This type of scenario is referred to as a horizontal and cross-silo FL setting.

Returning now to FIG. 1, the general goal of clients C₁, . . . , Cₙ of parties P₁, . . . , Pₙ is to collaboratively train a global decision tree T* (reference numeral 110) using their respective training datasets D₁, . . . , Dₙ such that T* is as close as possible in its qualities (such as accuracy and bias) to a decision tree that is trained on a single training dataset comprising the aggregation of D₁, . . . , Dₙ. For example, in the case where parties P₁, . . . , Pₙ are hospitals and training datasets D₁, . . . , Dₙ are patient record databases as mentioned above, the hospitals may wish to collaboratively train a shared decision tree on their respective databases that can be used for diagnosing one or more medical conditions. A decision tree is an ML model that takes the form of a rooted binary tree, or in other words a tree with a single root node and at most two children per internal node (i.e., a left child and a right child). For example, FIG. 3 depicts a sample decision tree 300 with six nodes 302-312. As shown in FIG. 3, the root node of the tree (reference numeral 302) is denoted as n_{ε} (where ε refers to an empty bitstring) and, for every internal node nₓ, its left and right children are denoted as nₓ₀ and nₓ₁ respectively. Thus, the left child of root node n_{ε} is n₀ (reference numeral 304), the right child of root node n_{ε} is n₁ (reference numeral 306), the left child of n₀ is n₀₀ (reference numeral 308), the right child of n₀ is n₀₁ (reference numeral 310), and the left child of n₁ is n₁₀ (reference numeral 312).

Generally speaking, each node nₓ of a decision tree is associated with three components: (1) a dataset D^{x}⊆D^{π(x)} having a size (i.e., number of rows) R^{x}=|D^{x}|; (2) a verdict function V^{x}:Z₁× . . . ×Z_{c}→{0,1}∪L such that, given an input data instance, V^{x} outputs a value l where l∈L if nₓ is a leaf node and l∈{0,1} if nₓ is an internal node; and (3) a feature f^{x}∈F on which dataset D^{X} is “split” at nₓ using verdict function V^{x}. For example, if feature f^{ε} of the root node n_{ε} is “days of the week,” verdict function V^{ε} may be the following: output 0 (i.e., traverse to left child n₀) if the value of f^{ε} is Wednesday, otherwise output 1 (i.e., traverse to left child n₁). Dataset D^{ε} of root node n_{ε} comprises the entirety of the training dataset used to train the tree and D^{ε} is progressively partitioned (i.e., split) via the features and verdict functions of lower nodes in the tree, resulting in the corresponding datasets at those nodes.

These per-node components are determined as part of the decision tree training process and are used during an inference procedure to predict a classification for a sample data instance s∈Z₁× . . . . ×Z_{c} using the trained tree. More specifically, the inference procedure for sample data instance s begins at root node n_{ε} and while the current node nₓ is not a leaf, the procedure computes b=V^{x} (s) and traverses to child node n_{xb}. This continues until current node nₓ is a leaf node, at which point the inference procedure outputs V^{x}(s) as the predicted classification for s.

A simple approach that allows clients C₁, . . . , Cₙ to train global decision tree T* per the scenario of FIG. 1 involves joining together training datasets D₁, . . . , Dₙ at a single location (e.g., at one of the clients) and then carrying out conventional decision tree training on the joint dataset. This however has two disadvantages: (1) the overall communication needed to carry out the training is proportional to the size of the joint dataset, which may be very large; and (2) the client that performs the join operation will necessarily have access to the other clients' training datasets, thereby violating the data privacy requirement mentioned above.

An alternative approach involves applying an existing federated decision tree learning protocol that is capable of guaranteeing data privacy. However, most existing protocols produce decision trees with relatively poor predictive accuracy and/or rely on complex cryptographic primitives such as public/private key encryption that add significant overhead to the learning process.

To address the foregoing and other similar issues, embodiments of the present disclosure provide a new federated decision tree learning protocol (PSI4FDTL) that leverages a variant of private set intersection (PSI) known as quorum private set intersection analytics (QPSIA). PSI is a cryptographic protocol that allows multiple parties P₁, . . . , Pₙ, each holding a set of items Sᵢ private to Pᵢ, to learn the set intersection I=S₁∩ . . . ∩Sₙ (or in other words, the items that appear in all of the sets) and no other information. Quorum PSI (QPSI) is a generalization of PSI that is parameterized by a quorum parameter q and enables the parties to learn the set intersection I_{q} containing all items that appear in at least q (rather than all) sets. And QPSIA extends QPSI such that each item x in each set Sᵢ is associated with a payload pᵢ(x) and the output of the protocol is the result of an analytics function g ({pᵢ (x)|x∈I_{q}∩Sᵢ}) where I_{q} is the set intersection of items computed via QPSI. That is, for every item x∈I_{q}, analytics function g is provided as input the payload pᵢ (x) from every set Sᵢ that x is a member of.

With this explanation of PSI, QPSI, and QPSIA in mind, PSI4FDTL can generally proceed as follows with respect to clients C₁, . . . , Cₙ of FIG. 1:
1. Each client Cᵢ generates a local decision tree Tᵢ using its training dataset Dᵢ.
2. Each client Cᵢ generates a set of items Sᵢ where each item x in Sᵢ corresponds to a subtree of its local decision tree Tᵢ and is associated with a payload pᵢ (x) containing the feature(s), verdict function(s), and certain statistics (e.g., dataset size(s)) for the node(s) in the subtree. As used herein, a subtree T′ of a decision tree T is a connected sub-graph of T that contains T′s root node n_{ε}. Further, a decision subtree is also a decision tree.
3. Clients C₁, . . . , Cₙ run a QPSIA protocol using their respective sets S₁, . . . , Sₙ as input, resulting in the determination of an initial subtree of global decision tree T* (including a feature and verdict function for each node in that subtree). The determined subtree is the one that is deemed to be most appropriate for global decision tree T* by the QPSIA protocol's analytics function g from among all subtrees that appear in at least q of the sets S₁, . . . , Sₙ (and thus, in at least q of the clients' local decision trees).
4. For each leaf node nₓ of the determined subtree, clients C₁, . . . , Cₙ reach an agreement on whether or not to extend global decision tree T* from nₓ; if so, the clients recursively invoke the PSI4FDTL protocol from that point with the determined subtree of T* in place (i.e., such that each client Cᵢ generates a new local decision tree Tᵢ per step (1) using dataset Dᵢ^{x} of nₓ, rather than the entire training dataset Dᵢas in the initial iteration).
5. The protocol continues until no more leaf extensions are agreed upon; the composition of global decision tree T* at this juncture is the final, trained form of T*.

With this general protocol design, several advantages are realized. First, by leveraging QPSIA, PSI4FDTL can efficiently and effectively find the “best” subtree to include in global decision tree T* at each protocol iteration, where the best subtree is the one that appears at least a threshold number of times in the clients' respective local decision trees per quorum parameter q (which means it is likely to be important for decision making purposes) and is selected by analytics function g based on an analysis of the subtrees' respective features, verdict functions, and statistics. In certain embodiments, as part of its logic, analytics function g can also compute an optimal verdict function for each node of this subtree that is derived from the verdict functions for that node as found in the corresponding subtree payloads in S₁, . . . , Sₙ.

Second, due to the privacy preserving nature of PSI/QPSI/QPSIA (which do not reveal anything beyond the computed set intersection to the participating parties), PSI4FDTL can ensure that this subtree determination is made in a manner that does not compromise the secrecy of training datasets D₁, . . . , Dₙ. Accordingly, the data privacy requirement for the cross-silo FL setting shown in FIG. 1 is kept intact.

It should be appreciated that FIGS. 1-3 and the foregoing high-level description of PSI4FDTL are illustrative and not intended to limit embodiments of the present disclosure. For example, although FIG. 1 depicts a particular arrangement of entities within FL environment 100, other arrangements are possible (e.g., the functionality attributed to a particular entity may be split into multiple entities, entities may be combined, etc.). One of ordinary skill in the art will recognize other variations, modifications, and alternatives.

### 2. Protocol Workflow

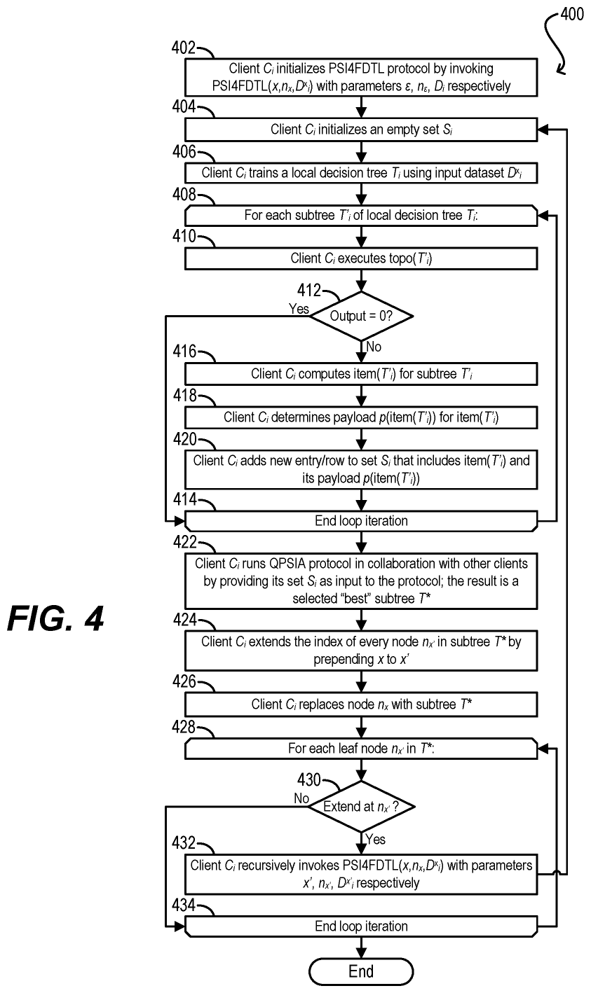

FIG. 4 depicts a workflow 400 that provides additional details regarding the processing that may be performed by each client Cᵢ of FIG. 1 to carry out PSI4FDTL according to certain embodiments. Workflow 400 assumes that PSI4FDTL is implemented as a recursive protocol

PSI4FDTL (x, nₓ, Dᵢ^{x}, . . . , Dₙ^{x}) that takes as input a node index x, a decision tree node corresponding to index x (i.e., nₓ), and dataset Dᵢ^{x} for node nₓ held by the executing client Cᵢ.

Further, workflow 400 assumes that PSI4FDTL is parameterized with a quorum parameter q and an analytics function g that are passed to the QPSIA protocol used within each PSI4FDTL iteration. Quorum parameter q is a threshold value indicating the quorum that needs to be met for the QPSIA protocol to include a set item in the set intersection I_{q} and analytics function g is the function executed by QPSIA. The specific values/implementations of these parameters are left open, with the only requirement being that analytics function g takes as input a set of decision trees/subtrees (in the form of set items) and corresponding payloads and outputs a single decision tree/subtree.

Yet further, workflow 400 assumes the availability of two helper functions: topo (T) and item (T). The topo (T) function takes as input a decision tree T and outputs 1 if T meets a topology requirement and 0 otherwise. In the context of PSI4FDTL, this topology requirement may be a desired maximum size of decision tree T (such as, e.g., a maximum height/depth, maximum width, etc.) and thus can be used to control the sizes of the subtrees that are considered in each protocol iteration.

The item (T) function takes as input a decision tree T and outputs a concise fingerprint of T such that for different decision trees T₁ and T₂, the probability that item (T₁)=item (T₂) is negligible. In a particular embodiment, the output of item (T) can be defined as the result of a hash function over the list (x₁, f^{x}^{₁}), . . . , (xₜ, f^{x}^{ₜ}) where nₓ_{₁}, . . . , nₓ_{ₜ} are the nodes of decision tree T and x₁ <. . . <xₜ.

Starting with step 402 of workflow 400, client Cᵢ can initialize the protocol by invoking PSI4FDTL (ε, n_{ε}, Dᵢ), or in other words passing as input to the protocol ε (empty bitstring) for parameter x, n_{ε} for parameter nₓ, and training dataset Dᵢ for parameter Dᵢ^{x}.

At step 404, client Cᵢ can initialize an empty Sᵢ. Client Cᵢ can then train a local decision tree Tᵢ using the input dataset Dᵢ^{x}, which is initially Dᵢ (step 406). The client may use any known decision tree training algorithm for carrying out this training of local decision tree Tᵢ.

At step 408, client Cᵢ can enter a loop for each subtree T′ᵢ of local decision tree Tᵢ. Within this loop, client Cᵢ can execute topo (T′ᵢ) (step 410) and check whether the output of this function is 0 (step 412). If so, client Cᵢ can proceed directly to the end of the loop iteration (step 414).

However, if the topo function outputs 1, client Cᵢ can conclude that subtree T′ᵢ should be considered as a candidate subtree for global decision tree T*. Accordingly, client Cᵢ can compute a unique fingerprint for subtree T′ᵢ by executing item (T′ᵢ) (step 416) and determine a payload p (item (T′ᵢ)) for this subtree (step 418). In one set of embodiments, assuming subtree T′ᵢ is composed of t nodes, payload p (item (T′ᵢ)) can include the value t and a list of tuples comprising the node index, verdict function, and dataset size for each node in T′ᵢ (i.e., the list (x₁, R^{x}, V^{x}^{₁}), . . . , xₜ,R^{x}^{ₜ}, V^{x}^{ₜ})).

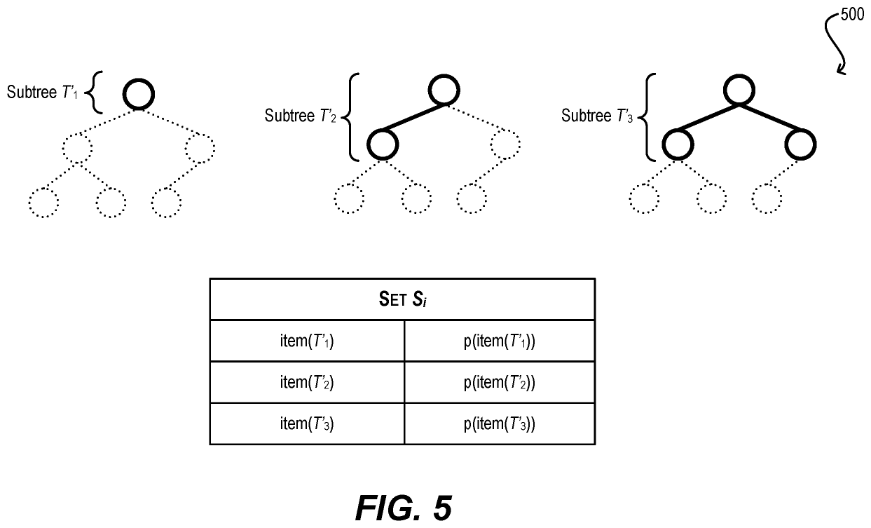

Upon computing/determining item (T′ᵢ) and payload p (item (T′ᵢ)), client Cᵢ can add a new entry/row to set Sᵢ that includes these two components (step 420). Client Cᵢ can then reach the end of the current loop iteration (step 414) and repeats the loop until all of the subtrees of local decision tree Tᵢ have been processed. By way of example, FIG. 5 depicts a scenario 500 in which client Cᵢ has identified three subtrees T′₁, T′_{2,} and T′₃ of its local decision tree Tᵢ that satisfy the topology requirement of the topo function (shown in bold) and has added three rows for these respective subtrees to its set Sᵢ in accordance with steps 416-420.

Once all clients C₁, . . . , Cₙ have reached step 420 for the current PSI4FDTL iteration (and thus have built their respective sets S₁, . . . , Sₙ), client Cᵢ can run a QPSIA protocol in collaboration with the other clients by providing its set Sᵢ as input to the protocol (along with the quorum parameter q and analytics function g inherited from PSI4FDTL) (step 422). The execution of this QPSIA protocol will cause analytics function g to take as input the payloads of the items (i.e., subtrees) in sets S₁, . . . , Sₙ that appear in at least q sets and output to each client a single, “best” subtree (denoted as T*) from among those items/subtrees for inclusion in the global decision tree.

In various embodiments, the specific logic employed by analytics function g for identifying this best subtree can vary based on factors such as the nature of training datasets D₁, . . . , Dₙ, the problem that the global decision tree is intended to solve, and so on. However, the general intuition is that analytics function g will attempt to select a subtree that is most likely to maximize the predictive accuracy of the global decision tree and/or accelerate training. Thus, for example, if there are two subtrees T₁ and T₂ in sets S₁, . . . , Sₙ that meet quorum parameter q and the sizes of the datasets for Tᵢ's nodes are larger than the sizes of the datasets for Tᵢ's nodes (as recorded in their respective payloads), analytics function g may choose T₁ as the best subtree because dataset size is generally indicative of decision tree quality. Alternatively, if the size (i.e., number of nodes) of subtree T₂ is substantially larger than subtree T₁, analytics function g may choose T₂ as the best subtree (despite its smaller dataset sizes) because that will decide a larger portion of the global decision tree in the current PSI4FDTL iteration and thus speed up the overall training process.

As mentioned previously, in certain embodiments analytics function g can also calculate an “optimal” verdict function for each node of the selected best subtree based on the verdict functions of the nodes of that subtree, as found in the payloads of sets S₁, . . . , Sₙ. For instance, in a particular embodiment analytics function g may average together the verdict functions for each node to arrive at the optimal version.

Upon receiving best subtree T* as the output of the QPSIA protocol, client Cᵢ can extend the index of every node n_{x′} in T* by prepending index x (received as input to the current PSI4FDTL iteration), to the node's index x′ (step 424). In other words, the client can change the index of every node n_{x′} from x′ to x||x′. In the case where x=ε (as in the initial PSI4FDTL iteration), this will result in no change to the node indexes. Further, client Cᵢ can replace node nₓ (received as input to the current PSI4FDTL iteration) with subtree T* (step 426). These two steps essentially adjust the global decision tree built up to this point by the client to incorporate the best subtree determined by the QPSIA protocol.

Then for each leaf node n_{x′} in T* (which now represents the global decision tree), client Cᵢ can agree with the other clients on whether to extend the global decision tree at this leaf node or not (steps 428 and 430). The clients may use any conventional mechanism as defined in existing decision tree training algorithms to make this decision.

If the agreement at step 430 is to extend, client Cᵢ can recursively invoke PSI4FDTL (x′, n_{x′}, Dᵢ^{x′}), or in other words pass as input to the protocol the index x′ for parameter x, the leaf node n_{x′}, for parameter nₓ, and the dataset Dᵢ^{x′} of leaf node n_{x′} for parameter Dᵢ^{x} (step 432). Otherwise, the client can move on to the next leaf node n_{x′} in T* (step 434).

Once all of the leaf nodes have been processed, workflow 400 can end. Note that clients C₁, . . . , Cₙ will hold the final, trained version of the global decision tree as T* upon completion of all recursive iterations of PSI4FDTL.

Certain embodiments described herein can employ various computer-implemented operations involving data stored in computer systems. For example, these operations can require physical manipulation of physical quantities-usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method performed by each client of a plurality of clients participating in a federated learning (FL) procedure for training a global decision tree, said each client maintaining a training dataset that is inaccessible by other clients in the plurality of clients, the method comprising:
generating, by said each client, a local decision tree using the training dataset;
generating, by said each client, a set of items, wherein each item in the set of items corresponds to a subtree in the local decision tree and is associated with a payload comprising properties of nodes in the subtree;
executing, by said each client in collaboration with the other clients in the plurality of clients, a quorum private set intersection analytics (QPSIA) protocol, the executing including providing the set of items as input to the QPSIA protocol; and
determining, by said each client, a trained portion of the global decision tree based on an output of the QPSIA protocol.

2. The method of claim 1 wherein generating the set of items comprises, for each subtree in the local decision tree:
checking whether said each subtree meets a topology requirement; and
upon determining that said each subtree meets the topology requirement:
computing a unique fingerprint for said each subtree;
computing a payload for said each subtree; and
adding the unique fingerprint and the payload as a new item to the set of items.

3. The method of claim 2 wherein computing the unique fingerprint comprises computing a hash of a subset of the properties of the nodes in said each subtree.

4. The method of claim 1 wherein the payload comprises, for each node in the subtree:
a feature from the training dataset that is associated with said each node;
a verdict function that is associated with said each node; and
a size of a dataset that is associated with said each node.

5. The method of claim 1 wherein the output of the QPSIA protocol is a particular subtree selected from among all subtrees that appear in at least a threshold number of sets provided as input to the QPSIA protocol, and wherein the particular subtree is deemed to be a best subtree for the global decision tree by an analytics function of the QPSIA protocol.

6. The method of claim 5 wherein the analytics function determines that the particular subtree is the best subtree based on the payloads associated with the particular subtree in the sets.

7. The method of claim 1 further comprising, for each leaf node of the trained portion of the global decision tree:
determining that the global decision tree should be extended at the leaf node; and
recursively performing the method of claim 1 under an assumption that the trained portion of the global decision tree is fixed in place.

8. A non-transitory computer readable storage medium having stored thereon program code executable by each client of a plurality of clients participating in a federated learning (FL) procedure for training a global decision tree, said each client maintaining a training dataset that is inaccessible by other clients in the plurality of clients, the program code causing said each client to:
generate a local decision tree using the training dataset;
generate a set of items, wherein each item in the set of items corresponds to a subtree in the local decision tree and is associated with a payload comprising properties of nodes in the subtree;
execute, in collaboration with the other clients in the plurality of clients, a quorum private set intersection analytics (QPSIA) protocol, the executing including providing the set of items as input to the QPSIA protocol; and
determine a trained portion of the global decision tree based on an output of the QPSIA protocol.

9. The non-transitory computer readable storage medium of claim 8 wherein generating the set of items comprises, for each subtree in the local decision tree:
checking whether said each subtree meets a topology requirement; and
upon determining that said each subtree meets the topology requirement:
computing a unique fingerprint for said each subtree;
computing a payload for said each subtree; and
adding the unique fingerprint and the payload as a new item to the set of items.

10. The non-transitory computer readable storage medium of claim 9 wherein computing the unique fingerprint comprises computing a hash of a subset of the properties of the nodes in said each subtree.

11. The non-transitory computer readable storage medium of claim 8 wherein the payload comprises, for each node in the subtree:
a feature from the training dataset that is associated with said each node;
a verdict function that is associated with said each node; and
a size of a dataset that is associated with said each node.

12. The non-transitory computer readable storage medium of claim 8 wherein the output of the QPSIA protocol is a particular subtree selected from among all subtrees that appear in at least a threshold number of sets provided as input to the QPSIA protocol, and wherein the particular subtree is deemed to be a best subtree for the global decision tree by an analytics function of the QPSIA protocol.

13. The non-transitory computer readable storage medium of claim 12 wherein the analytics function determines that the particular subtree is the best subtree based on the payloads associated with the particular subtree in the sets.

14. The non-transitory computer readable storage medium of claim 8 wherein the program code further causes the client to, for each leaf node of the trained portion of the global decision tree:
determine that the global decision tree should be extended at the leaf node; and
recursively execute the program code of claim 8 under an assumption that the trained portion of the global decision tree is fixed in place.

15. A computer system participating in a federated learning (FL) procedure with other computer systems for training a global decision tree, the computer system comprising:
a processor;
a training dataset that is inaccessible to the other computer systems; and
a non-transitory computer readable medium having stored thereon program code that, when executed by the processor, causes the processor to:
generate a local decision tree using the training dataset;
generate a set of items, wherein each item in the set of items corresponds to a subtree in the local decision tree and is associated with a payload comprising properties of nodes in the subtree;
execute, in collaboration with the other computer systems, a quorum private set intersection analytics (QPSIA) protocol, the executing including providing the set of items as input to the QPSIA protocol; and
determine a trained portion of the global decision tree based on an output of the QPSIA protocol.

16. The computer system of claim 15 wherein generating the set of items comprises, for each subtree in the local decision tree:
checking whether said each subtree meets a topology requirement; and
upon determining that said each subtree meets the topology requirement:
computing a unique fingerprint for said each subtree;
computing a payload for said each subtree; and
adding the unique fingerprint and the payload as a new item to the set of items.

17. The computer system of claim 16 wherein computing the unique fingerprint comprises computing a hash of a subset of the properties of the nodes in said each subtree.

18. The computer system of claim 15 wherein the payload comprises, for each node in the subtree:
a feature from the training dataset that is associated with said each node;
a verdict function that is associated with said each node; and
a size of a dataset that is associated with said each node.

19. The computer system of claim 15 wherein the output of the QPSIA protocol is a particular subtree selected from among all subtrees that appear in at least a threshold number of sets provided as input to the QPSIA protocol, and wherein the particular subtree is deemed to be a best subtree for the global decision tree by an analytics function of the QPSIA protocol.

20. The computer system of claim 19 wherein the analytics function determines that the particular subtree is the best subtree based on the payloads associated with the particular subtree in the sets.

21. The computer system of claim 15 wherein the program code further causes the processor to, for each leaf node of the trained portion of the global decision tree:
determine that the global decision tree should be extended at the leaf node; and
recursively execute the program code of claim 15 under an assumption that the trained portion of the global decision tree is fixed in place.
